(19) United States
(12) Patent Application Publication
(10) Pub. No.: US 2026/0212331 A1
(43) Pub. Date: Jul. 23, 2026

(54) Blockchain Architecture for Fiat-Denominated Smart Contract Execution via Oracle-Linked NAV

(71) Applicant: Blue Water Research LLC, Sheridan, WY (US)

(72) Inventor: Richard Uhlig, Sheridan, WY (US)

(73) Assignee: Blue Water Research LLC, Sheridan, WY (US)

(21) Appl. No.: 19/182,197

(22) Filed: Apr. 17, 2025

Related U.S. Application Data
(60) Provisional application No. 63/833,839, filed on Jan. 22, 2025.
(60) Provisional application No. 63/834,211, filed on Mar. 3, 2025.
(60) Provisional application No. 63/834,546, filed on Mar. 28, 2025.

(51) Int. Cl. G06Q 20/06; G06Q 20/10; G06Q 20/36

(52) U.S. Cl. CPC G06Q 20/065; G06Q 20/10; G06Q 20/36; G06Q 2220/00

(57) ABSTRACT

A system and method are disclosed for executing fiat-denominated transactions using cryptocurrency coins fully collateralized by off-chain financial assets. The system calculates a dynamic Net Asset Value (NAV) by dividing the fair value of collateral assets, net of liabilities, by the number of outstanding coins. The NAV is periodically published to the blockchain via an oracle interface to ensure authenticity. All user interactions—purchases, redemptions, and transfers—are initiated through smart contracts that accept fiat-denominated inputs. Smart contracts retrieve the NAV from the blockchain and deterministically compute the required number of coins. This architecture performs all fiat-to-coin conversions on-chain through immutable contract logic, eliminating reliance on external systems. Authentication, balance verification, and ledger updates are enforced on-chain, with transaction events emitted for transparency. By embedding returns in the NAV and avoiding identity-based income distribution, the system enables technically robust, pseudonymous yield accrual compatible with decentralized blockchain infrastructure.

### CROSS-REFERENCE TO RELATED CASES

The present application claims benefit to U.S. Provisional Patent Application No. 63/833,839 , filed on Jan. 22, 2025; U.S. Provisional Patent Application No. 63/834,211 , filed on Mar. 3, 2025; and U.S. Provisional Patent Application No. 63/8XX,XXX, filed on Mar. 28, 2025 (with the same inventor as the present application and having a title of “Method for Creating a Yield-Earning Digital Asset Fully Collateralized by Fiat Currency, Sovereign Debt, Other Financial Assets, and/or Commodities”); all of which are hereby incorporated by reference in their entireties.

### TECHNICAL FIELD

This disclosure relates generally to the integration of distributed ledger systems with traditional financial assets to create novel value exchange mechanisms.

### BACKGROUND

Cryptocurrencies are digital assets that serve as decentralized mediums of value exchange. Unlike traditional currencies managed by central banks or financial institutions, cryptocurrencies operate on distributed ledger technologies—most commonly blockchains—that cryptographically secure transactions, regulate the issuance of new tokens, and ensure verifiable transfer of ownership. This decentralized architecture eliminates the need for intermediaries, enabling peer-to-peer transactions that are secure, transparent, and resistant to tampering.

Among the most prominent cryptocurrencies are Bitcoin and Ethereum, which have gained significant global adoption and are frequently used for speculation, investment, and as alternatives to fiat currencies. Despite their popularity, their integration into everyday commerce remains limited, particularly in point-of-sale environments where immediate and stable value exchange is critical.

Merchants who choose to accept cryptocurrency as a form of payment face several operational and economic obstacles. First, there is uncertainty regarding whether the received cryptocurrency can be readily converted into fiat currency or used to pay other suppliers, creating friction in standard business processes. Additionally, pseudonymity in blockchain systems results in a lack of transparency that complicates compliance, fraud prevention, and accounting. Finally, and most notably, cryptocurrencies are subject to extreme price volatility. For example, in February 2025, the value of Bitcoin dropped from $102,345 to $80,376 within a single month, illustrating the potential for merchants to receive far less value than anticipated at the time of settlement.

To address these volatility and usability challenges, alternative systems have emerged that aim to provide price stability while retaining the core features of cryptocurrencies. Chief among these are so-called “stablecoins,” which are specifically designed to minimize price fluctuations while still operating on decentralized blockchain infrastructure. Stablecoins are a category of cryptocurrency designed to maintain a consistent value by pegging their worth to a stable reference asset, rather than relying on market-driven valuations like other cryptocurrencies. This peg may be linked to a single asset—such as a fiat currency like the US dollar—or to a basket of assets that can include sovereign debt instruments, exchange-traded commodities like gold, or other highly liquid financial assets. To maintain this stability, stablecoins are typically fully collateralized by these backing assets. Transactions involving stablecoins are conducted on decentralized blockchain networks, offering the advantages of fast settlement, pseudonymous ownership, and low transaction costs—often as little as 0.06% of the transaction value—making them attractive for both retail and institutional value transfers.

Although stablecoins offer price stability, they are typically backed by real-world financial assets—such as fiat currencies, government bonds, or other investment-grade instruments—that naturally accrue interest or yield over time. For example, government money market funds earn a yield which approximates the Fed Funds rate (above 4.0% in Spring of 2025). In most existing implementations, however, the return generated by these collateral assets is typically retained by the issuer or managing entity rather than passed through to stablecoin holders. For example, in most fiat-backed stablecoins such as Tether (USDT) and USD Coin (USDC), the interest earned on the reserve assets—like Treasury bills or bank deposits—is used to fund operational costs or retained as revenue by the issuer, not distributed to holders of the stablecoin. This means the yield earned on stablecoins is 0.0%, even though they are collateralized to a degree similar to money market funds. Because stablecoins are not designed to appreciate in value like volatile cryptocurrencies such as Bitcoin, this lack of yield creates a disincentive to hold stablecoins for extended periods. As a result, users often prefer to hold their funds in other yield-bearing instruments or riskier crypto assets that offer the possibility of capital appreciation.

Various prior art mechanisms have been proposed for enabling yield on cryptocurrency holdings. For example, Compound Finance is a decentralized finance (DeFi) protocol that allows users to lend crypto assets and earn interest without intermediaries. Deposited tokens are automatically converted into protocol-specific tokens called cTokens. Similarly, the Aave protocol issues aTokens to represent user deposits in liquidity pools. Many related protocols follow the same model: users deposit assets and receive a new token—often referred to generically as an xToken—which represents a proportional claim on the pooled assets. In some implementations, yield is provided through the algorithmic accrual of additional xTokens over time. When a user withdraws funds, the xTokens are redeemed for the underlying asset plus accumulated interest. However, this architecture introduces technical inefficiencies. Specifically, the need to convert between standard tokens and interest-bearing xTokens increases computational complexity and related costs, adds latency, and impairs transaction speed. These conversion and reconciliation steps introduce architectural overhead and degrade the overall performance and usability of the system.

Other approaches attempt to tokenize government money market mutual funds by digitally representing fund ownership on a blockchain ledger. Although these systems retain certain benefits of blockchain infrastructure—such as transparent ownership tracking—they are structured as pass-through entities for tax purposes, requiring direct income distribution to identifiable holders. This design benefits only the initial buyers whose identities are known at the time of purchase. Once tokens are transferred to secondary holders whose identities are pseudonymous to the issuer, the system cannot fulfill regulatory or tax obligations tied to income distribution. As a result, such transfers are often technically infeasible or legally impermissible, severely limiting the utility and transferability of the tokenized assets. Some systems attempt to resolve this by requiring secondary holders to forfeit pseudonymity and comply with Know Your Customer (KYC) regulations. However, these identity-verification requirements introduce substantial operational overhead and undermine one of the core architectural features of blockchain systems—permissionless, pseudonymous ownership and transferability.

### SUMMARY

The embodiments described herein address technical deficiencies inherent in traditional stablecoin architectures by implementing a smart contract-based system for coin acquisition, redemption, and transfer. These smart contracts operate exclusively on fiat-denominated inputs and utilize a blockchain-published Net Asset Value (NAV), accessed via a tamper-evident oracle interface, to deterministically compute the number of cryptocurrency coins involved in each transaction. This architecture reduces operational overhead by eliminating off-chain conversion logic, supports pseudonymous ownership and transferability, and improves system performance by ensuring all value resolution and transaction execution occur on-chain. By removing the need for manual or identity-dependent processes, the disclosed system enhances scalability, auditability, and integration with decentralized financial infrastructure.

A further technical advantage of the disclosed system is that it enables holders of fully collateralized cryptocurrency coins—including those pseudonymous to the issuer—to accrue returns throughout their ownership period without requiring direct income distributions. This is achieved by reinvesting net income into the token's NAV, thereby embedding yield directly into the token's valuation. Unlike prior systems that rely on dual-token mechanics or periodic interest distributions, the disclosed architecture allows return accrual to occur passively and automatically within the core transactional token itself. This eliminates the complexity of switching between spendable tokens and investment tokens or issuing fractionalized interest-bearing assets. By enabling real-time settlement through deterministic smart contracts and removing reliance on intermediaries such as payment processors, the system further reduces transaction costs and eliminates traditional interchange fees, all while preserving core blockchain properties such as transparency, pseudonymity, and composability.

Disclosed herein is a system for a tokenized cryptocurrency that (i) is fully backed by fiat currency, sovereign debt, other financial assets and/or exchange-traded commodities, (ii) represents ownership through easily transferable digital tokens maintained on a decentralized blockchain ledger, and (iii) delivers a financial return to token holders via the systematic retention and reinvestment of income earned by the underlying assets. This financial return accrues from the moment a buyer acquires the cryptocurrency tokens and continues until the buyer sells, transfers, or redeems them. Unlike conventional models requiring direct income distributions, this system builds financial returns directly into the value of the tokens themselves, thereby enabling pseudonymous, frictionless yield accrual without compromising transactional efficiency or blockchain integrity.

In the disclosed embodiments, the acquisition, transfer, and redemption of these coins are immutably recorded on a decentralized, blockchain-based ledger, ensuring secure and transparent ownership tracking. To enable precise and automated transaction execution, the system must calculate the Net Asset Value (NAV) of each cryptocurrency coin in real time. The NAV is computed as the fair value of the investment vehicle's total assets, net of all liabilities, divided by the total number of cryptocurrency coins in circulation. This NAV data is continuously updated and maintained off-chain by the investment vehicle or its agent. To support smart contract operations, the current NAV—and optionally its historical values—must be made available to the blockchain as a trusted data input. This is accomplished through a secure oracle mechanism that feeds real-time NAV data into smart contracts, allowing accurate and autonomous conversion between fiat currency values and cryptocurrency coin quantities during transactions. The reliability and integrity of the NAV oracle are essential for ensuring correctness and consistency in all blockchain-executed operations.

Wallet-to-wallet transfers, as well as requests for the purchase, sale, or redemption of the digital token, are executed via smart contracts deployed on a blockchain. These transactions are denominated in fiat currency terms rather than in units of the digital coin. Such transactions require an accurate, real-time Net Asset Value (NAV) to determine the corresponding quantity of digital coins. The smart contract executing the transaction determines the appropriate number of coins by dividing the fiat-denominated transaction amount by the current Net Asset Value (NAV) of the coin. The current NAV is accessed by the smart contract through an on-chain data feed maintained by an off-chain oracle service. Although the oracle operates off-chain, in one embodiment it regularly posts signed, timestamped NAV data to the blockchain, where it becomes available to smart contracts in a tamper-evident and verifiable format. This setup enables smart contracts to execute deterministic NAV-based conversions and transfers directly on-chain, eliminating reliance on external calls and preserving trustless execution. The calculated number of coins is automatically transferred and recorded on the blockchain, with any applicable transaction fees incorporated into the fiat-denominated transaction total. This architecture provides a secure, automated, and efficient mechanism for managing value exchange, supporting real-time token operations tied to up-to-date asset valuations.

As explained above, stablecoins that offer the benefits of price stability and decentralized transferability also face fundamental limitations that prevent them from offering yield to holders. These limitations are not merely financial or regulatory in nature—they arise from core technical constraints within blockchain infrastructure. Specifically, the decentralized, pseudonymous design of blockchain networks makes it infeasible to identify coin holders for the purpose of executing compliant, individualized income distributions. This identity gap creates a technical mismatch between existing blockchain systems and the requirements of yield allocation, particularly where legal frameworks demand recipient-level attribution for tax or anti-money-laundering compliance. Prior solutions have attempted to overcome this barrier through mechanisms such as dual-token models, rebasing systems, or smart contracts that distribute periodic interest. However, these approaches introduce significant architectural complexity, computational overhead, and volatility in token value—undermining the very price stability that makes stablecoins attractive.

The invention described herein addresses these technical shortcomings not by attempting to retrofit identity onto a decentralized system, but by fundamentally rethinking the concept of a stable cryptocurrency. By eliminating the need for direct distributions and instead embedding net returns into the token's Net Asset Value (NAV), the system enables all holders—regardless of identity—to participate in yield accrual passively. By altering the processing of smart contract transactions, the system enables both commercial and private party transactions to occur pseudonymously on a blockchain while maintaining compatibility with fiat-denominated pricing. This technical architecture avoids the need for identity-dependent income distribution by shifting value accrual to the token level. Rather than distributing yield directly, the system reflects net returns through changes in the NAV of the token, which smart contracts use in real-time to compute token transfers. Because the NAV is dynamically derived from the appreciation of underlying financial assets—not pegged rigidly to a fixed fiat value—holders benefit from passive yield accumulation without disrupting transaction accuracy or blockchain efficiency. This approach preserves the permissionless and pseudonymous nature of blockchain transactions while resolving the underlying technical barrier that has limited the evolution of stablecoins into yield-generating digital assets.

### BRIEF DESCRIPTION OF THE DRAWINGS

FIG. 1 provides a schematic diagram of a system for implementing a disclosed embodiment of the present invention including communication with a blockchain.

FIG. 2 provides a schematic diagram showing the system of FIG. 1 including communication over a network.

FIG. 3 is a flow chart showing an overall method for implementing one embodiment of the present invention.

FIG. 4 is a flow chart showing a method for initiating the system of FIG. 1.

FIG. 5 is a flow chart showing a method for acquiring coins.

FIG. 6 is a flow chart showing a method for redeeming coins.

FIG. 7 is a flow chart showing a method for a merchant transaction.

FIG. 8 is a flow chart showing a method for a peer-to-peer transaction.

FIG. 9 is a flow chart showing a method for operating a smart contract pursuant to the disclosed embodiment.

### DETAILED DESCRIPTION

### System 100

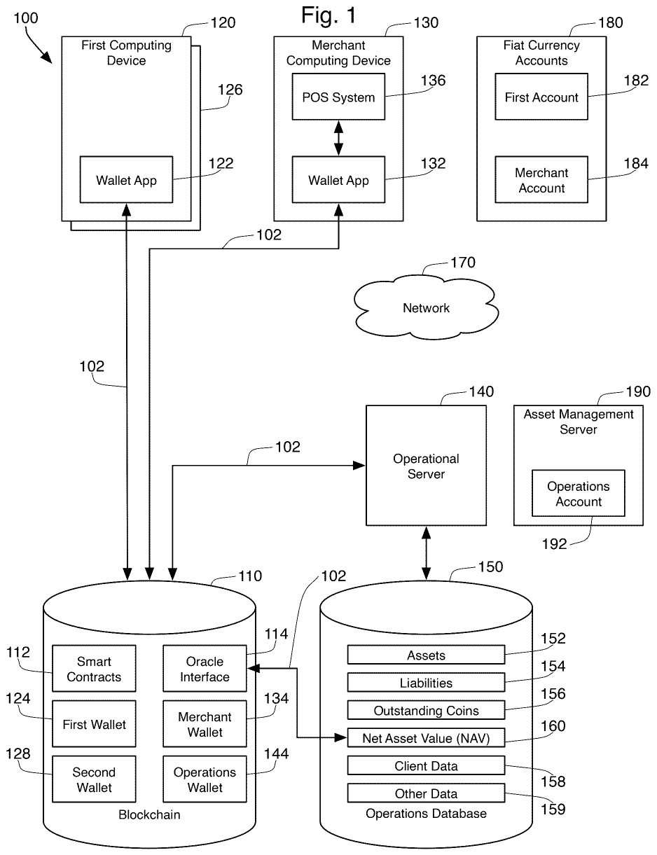

FIG. 1 shows a schematic illustration of a system 100 that includes a blockchain 110 that can interact with a first computing device 120, a merchant computing device 130, and an operational server 140. The blockchain 110 communicates with these other devices using blockchain communication paths 102. The system 100 is designed to implement one or more smart contracts 112 on the blockchain 110 in order to implement a novel stablecoin. The first computing device 120 has a wallet app 122 operating on the first computing device 120 to interact with a first wallet 124 on the blockchain 110. Similarly, the merchant computing device 130 has a wallet app 132 that interacts with a merchant wallet 134 on the blockchain 110, and the operational server 140 is able to interact with an operations wallet 144. In some embodiments, additional computer devices are also able to communicate with the blockchain 110. FIG. 1 shows a second computing device 126 behind the first computing device 120, which can be associated with a second wallet 128 on the blockchain using its own wallet app (not shown). FIG. 1 also shows a point-of-sale (POS) system 136 that provides point-of-sale services for the merchant. The POS system 136 allows the merchant to sell goods or services in exchange for payment. In the context of FIG. 1, the POS system 136 interacts with the wallet app 132 of the merchant in order to provide for payment utilizing coins on the blockchain 110.

Each of the computing devices shown in FIG. 1—including devices 120, 130, and 140—operates using at least one processor executing stored program instructions. These instructions are implemented as a combination of system software (such as an operating system) and application-level software configured to perform the described functions. The instructions are typically stored in non-transitory computer-readable media, including volatile memory (e.g., RAM) and non-volatile memory (e.g., flash memory, solid-state drives, or magnetic disks). During execution, portions of the instructions and associated data may be dynamically loaded from non-volatile memory into volatile memory for efficient processing. The computing devices may take the form of servers, desktop computers, laptop computers, or portable computing devices such as smartphones and tablets. These devices may operate independently or in concert with other computing devices, communicating over wired or wireless network connections. Each of the computing devices may also take the form of multiple, distinct devices. For example, operational server 140 may be formed utilizing a plurality of different individual servers, with each individual server either duplicating the work of other servers, performing its own functions, or both. Each computing device may store or retrieve data used by the software, including structured records in databases and unstructured data such as logs or digital files. The software may also generate and consume cryptographically signed data, particularly when interacting with the blockchain via smart contracts or the oracle interface described above.

The blockchain 110 is itself implemented as a distributed system comprising a plurality of computing devices (often referred to as nodes), each of which maintains a complete or partial copy of the blockchain ledger. These nodes execute consensus protocols to ensure consistency and integrity of data recorded across the network. Transactions recorded on the blockchain are grouped into blocks, each cryptographically linked to the previous one to form an immutable chain of data. This structure ensures that any attempt to alter or delete previously recorded information is easily detectable and rejected by the network. The blockchain also serves as a trustless execution environment for smart contracts—self-executing software programs that automatically enforce and perform contractual terms without the need for human intervention or third-party intermediaries. These technical properties make the blockchain 110 particularly well-suited for managing digital assets, recording asset ownership, and enabling autonomous financial transactions in a secure, transparent, and auditable manner.

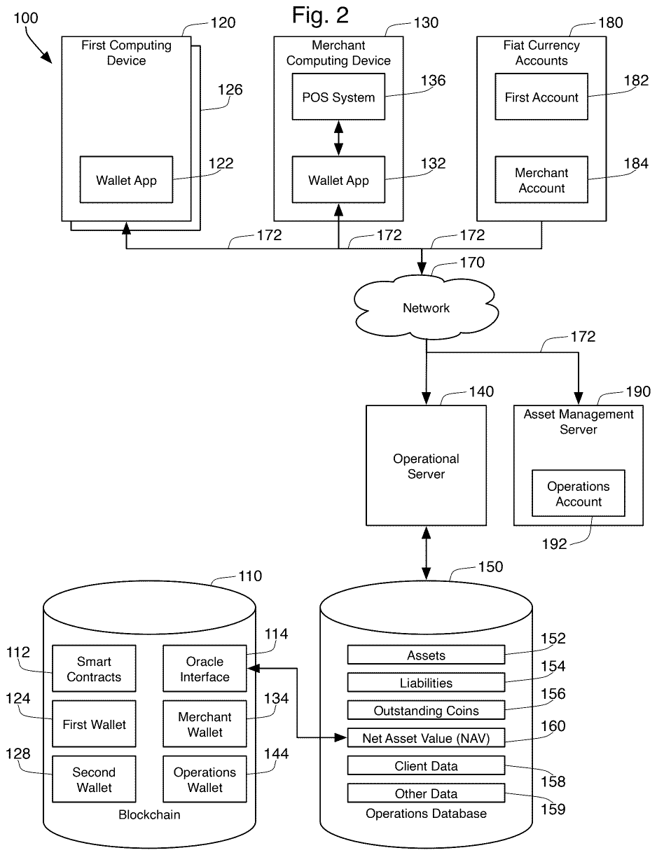

The blockchain communications 102 refer to interactions between off-chain components—such as computing devices, servers, and wallets—and the blockchain 110 itself. These communications are typically implemented through application programming interfaces (APIs), blockchain client libraries, or wallet-integrated interfaces that enable reading from and writing to the blockchain. Unlike the standard network communications shown in FIG. 2, which involve conventional client-server exchanges over IP-based networks (e.g., HTTPS requests), the blockchain communications 102 illustrated in FIG. 1 involve submitting signed transactions to a decentralized network for inclusion in a tamper-evident ledger. This may include broadcasting transaction payloads to a blockchain node, querying smart contract data, or responding to blockchain events. These blockchain communications enable smart contracts to coordinate and validate coin creation, transfers, redemptions, and other operations in a decentralized, transparent, and verifiable manner.

As explained in further detail below, the smart contracts 112 and the wallets 124, 128, 134, 144 implement a stablecoin that is backed by financial assets. The operational server 140 is responsible for understanding the value of these financial assets, and it does so by maintaining an operations database 150. The operations database 150 maintains data that identifies the assets sufficiently so as to calculate a value for the assets (assets value 152). The operations database 150 also maintains an understanding of outstanding liabilities and the value of those outstanding liabilities 154. These liabilities include accrued but unpaid fees, expenses, and taxes. Actual expenses incurred by the operator of the operational server 140 would result in a reduction of the value of the assets 152. Furthermore, although the operational server 140 can interact directly with the blockchain 110 that is responsible for minting and tracking the individual coins of the stablecoin currency, the operational server 140 can also maintain data about those coins, including the total number of outstanding coins 156, in the operations database 150.

As is also explained below, the operational server 140 is responsible for calculating the Net Asset Value (NAV) of each cryptocurrency coin. The NAV 160 of each cryptocurrency coin issued by the smart contracts 112 in the blockchain 110 is stored in the operations database 150. It is calculated as the then current fair value of all assets 152 net of all liabilities 154 divided by the then outstanding number of cryptocurrency coins 156 that have been issued. In other words, the NAV 160 is:
(Value of assets 152—value of liabilities 154)/Number of outstanding coins 156

The calculated NAV 160 must be made available to the smart contracts 112 operating on the blockchain 110. This is accomplished through the Oracle interface 114, which serves as a technical bridge for delivering reliable, off-chain financial data to an on-chain environment. The Oracle interface 114 can be implemented in a variety of ways to ensure accuracy, authenticity, and timely delivery of NAV data.

In one embodiment the Oracle interface 114 is realized by having the operational server 140 act as a centralized oracle. In this case, the server digitally signs and timestamps the NAV value 160 and then transmits it to the blockchain 110 as a transaction payload. Once recorded on-chain, this NAV 160 value becomes accessible to smart contracts 112 in a tamper-evident and verifiable format. This technical arrangement enables the smart contracts 112 to perform deterministic NAV-based conversions and token transfers based on current asset valuations without requiring real-time off-chain queries, thereby maintaining the trustless and autonomous nature of blockchain execution environments. The benefits of using a centralized oracle like this include implementation simplicity, low latency, and tight integration with the system's internal NAV calculation process. A centralized oracle can publish real-time data quickly and with minimal coordination overhead, enabling efficient and responsive smart contract execution. It also allows the system operator to maintain strict control over data accuracy and availability. However, there are disadvantages as well, namely that a centralized oracle introduces a single point of failure and requires trust in the entity operating the oracle. This might undermine the decentralized and trustless ethos of blockchain systems, making the system more vulnerable to data manipulation, downtime, or censorship. If the centralized oracle becomes compromised or unavailable, smart contracts 112 relying on its data may fail to execute correctly or securely.

Alternatively, the oracle interface 114 can be implemented using a decentralized oracle protocol, such as those based on threshold signatures or multi-party computation (MPC). In such implementations, the NAV value 160 calculated by the operational server 140 is cryptographically signed and pushed to a set of independent oracle nodes. These nodes validate the authenticity and consistency of the NAV data, and once consensus is reached, the aggregate data is posted on-chain in a tamper-evident format accessible to smart contracts 112. This decentralized model enhances security, reliability, and resilience by eliminating a single point of failure and enabling multiple independent nodes to validate and reach consensus on the accuracy of the NAV data. Decentralized oracles can also improve transparency by aggregating data from multiple sources, reducing the likelihood of manipulation or bias by any single party. Furthermore, the use of cryptographic signatures and consensus-based publication ensures data authenticity and auditability. However, decentralized oracles can introduce additional complexity, increased latency, and higher operational overhead due to the need for coordination among multiple nodes. These systems may also require more sophisticated governance and economic incentive mechanisms to ensure honest behavior and availability, which can complicate implementation and maintenance compared to centralized alternatives.

In other embodiments, the oracle interface 114 may be implemented through a time-locked data feed wherein the NAV value 160 is periodically committed to the blockchain 110 via hash-based commitments. At a later time, the full NAV data and associated metadata (e.g., timestamp, source references, signature) are revealed and validated against the earlier commitment. This ensures data integrity and non-repudiation while allowing smart contracts to operate deterministically on verifiable inputs.

These implementation options reinforce the trustless, decentralized characteristics of the blockchain 110, and provide a technical mechanism by which off-chain asset valuation data can reliably inform on-chain financial logic without exposing the system 100 to identity-based vulnerabilities or centralized data dependencies. In at least one preferred embodiment, implementation is made by a centralized oracle because rapid and reliable access to the most current NAV value 160 is critical for enabling real-time, deterministic execution of the smart contracts 112. Stablecoin transactions—such as purchases, redemptions, and peer-to-peer transfers—must be based on an accurate and up-to-date NAV 160 to ensure precise coin valuations and maintain user trust in the system's financial integrity. A centralized oracle minimizes latency by tightly coupling the off-chain NAV calculation with on-chain data publication, thereby ensuring that the smart contracts 112 always operate using the most recent and authoritative NAV value 160. Additionally, a centralized oracle allows for tighter operational control and simplified architecture, reducing the complexity associated with maintaining consensus across multiple oracle nodes. This streamlining enhances system reliability and performance while minimizing the risk of synchronization errors, stale data, or conflicting inputs.

FIG. 2 also shows the system 100, but this time components are interacting via network connections 172 over a network 170. The network 170 can take the form of a wide area network such as the Internet, although local area networks and storage area networks can be integrated as part of the overall network 170. The first computing device 120 (as well as the second computing device 126) and the merchant computing device 130 can communicate with each other and the operational server 140 over the network 170. The figures also show an element labeled fiat currency accounts 180. This component represents computers and institutions that hold financial accounts for the first computing device 120 and the merchant computing device 130, and thus might represent banks, banking computer systems, or banking networks. In some embodiments, the fiat currency accounts 180 component may also represent credit card systems and the like. The figures show that the fiat currency accounts 180 include a first account 182 for the first user and a merchant account 184 associated with the merchant operating the merchant computing device 130.

The figures also show an asset management server 190 that holds an account labeled in the figures as the operations account 192. In most embodiments, the operations account 192 is a stand-in for multiple accounts that hold the actual assets tracked by the assets 152 data in the operations database 150. These assets may include fiat currency, sovereign debt, and other financial assets and exchange traded commodities. It is expected that the vast majority of the assets will be cash, US government securities, and repurchase agreements that are collateralized solely by US government securities or cash. In most embodiments, the liquidity of these investments will be carefully managed.

It is expected that the real-world financial assets in the operations account 192 will earn income in the form of interest, dividends, and capital gains. Of course, these assets may also incur losses. These changes will, over time, change the value of the assets held in the operations account 192. As explained in further detail below, these changes in value of the assets are not directly distributed to the holders of the coins in the blockchain 110, but rather they are retained and used to alter the calculation of the NAV 160 by increasing or decreasing the value of the assets 152 tracked by the operations database 150.

The network connections 172 linking the first computing device 120, merchant computing device 130, fiat currency accounts 180, and the operational server 140 allow the various computing devices to interact directly with each other in circumstances that do not require the direct involvement of smart contracts 112 or reading of the values in the blockchain 110. For example, the network connections 172 allow a user of the first computing device 120 (a “first user”) and the merchant computing device 130 to become clients of the entity operating the operational server 140. Information about these clients 158 can also be stored in the operations database 150. Other data 159 can also be stored in the operations database 150 as needed to operate the overall system 100.

### Overall Method

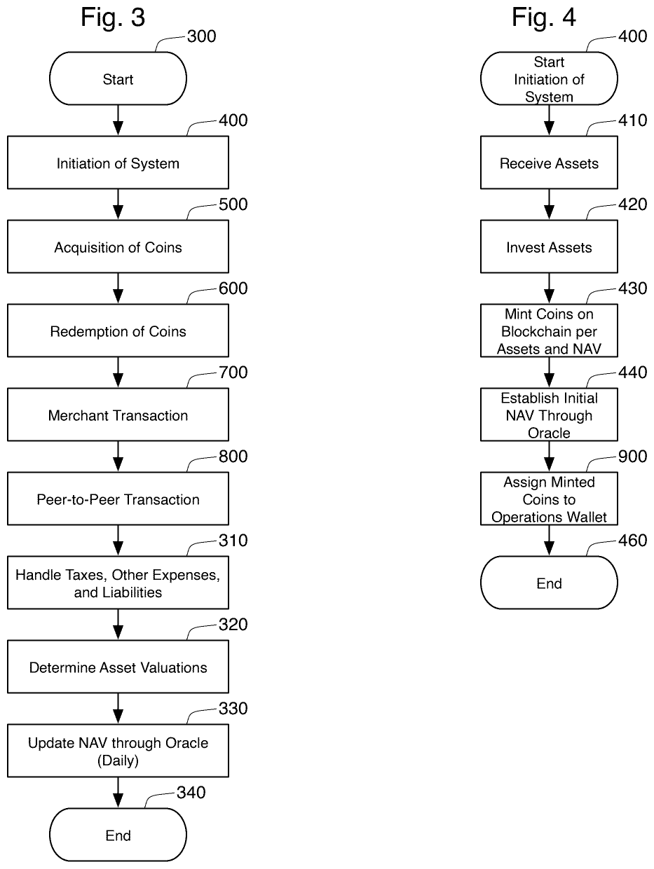

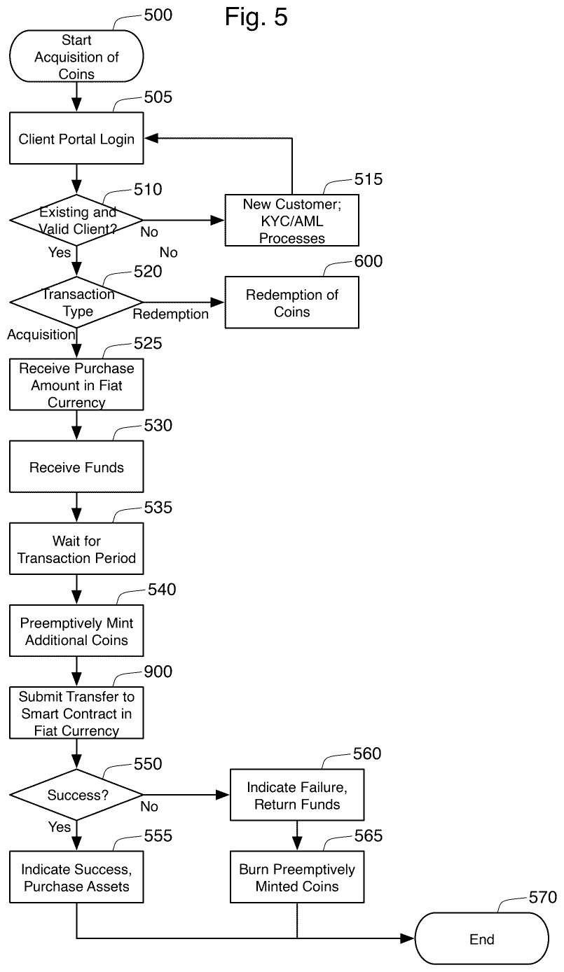

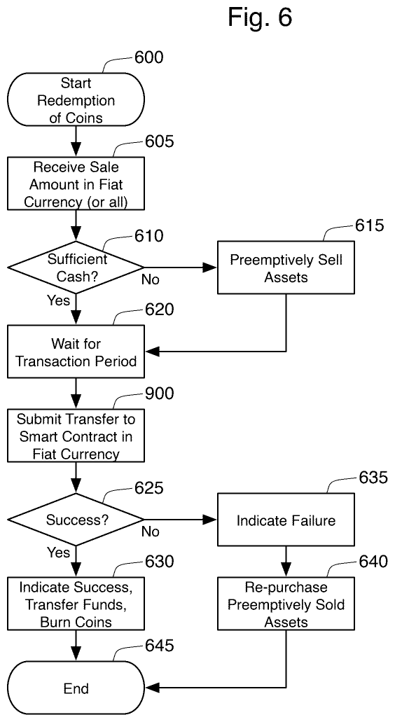

FIG. 3 shows an overall method 300 for utilizing system 100 to provide for a stablecoin using the unique, technical implementation disclosed herein. The first step of method 300 is the initiation method 400, which is shown as its own sub-method in FIG. 4 and is described in detail below. The initiation method 400 is responsible for initially funding the operations account 192, the initial minting of coins on the blockchain 110, and establishing an initial NAV 160. The second step is the coin acquisition method 500, which is also shown as its own sub-method in FIG. 5. The coin acquisition method 500 is responsible for accepting fiat currency from a user and for the transfer of coins to the appropriate wallet 124, 128, 134 on the blockchain 110. The third step of method 300 is the redemption method 600 that is shown in FIG. 6. The redemption method 600 allows users of the system 100 to redeem the coins held by their wallet 124, 128, 134 on the blockchain 110 back into fiat currency.

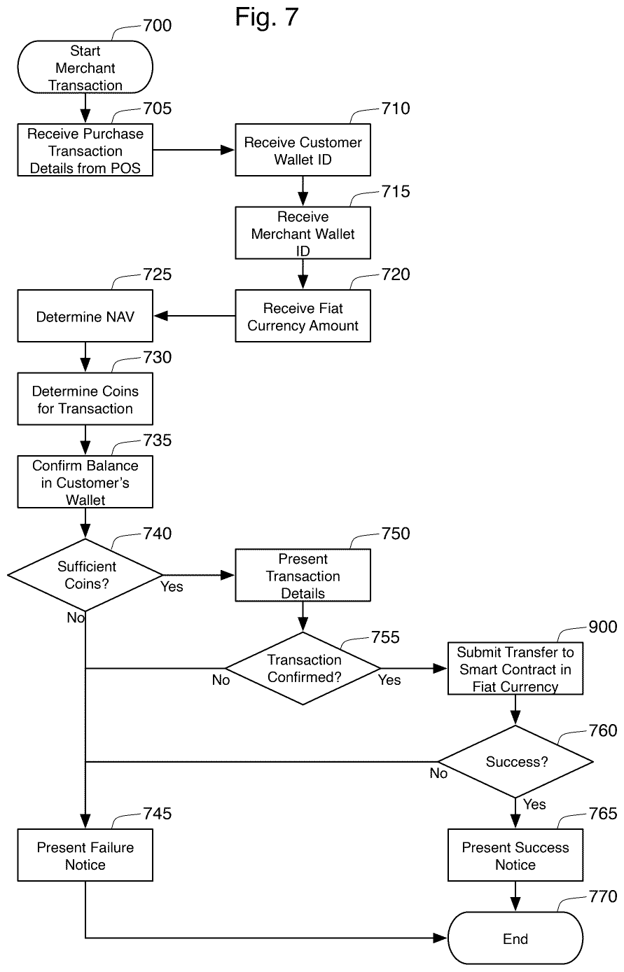

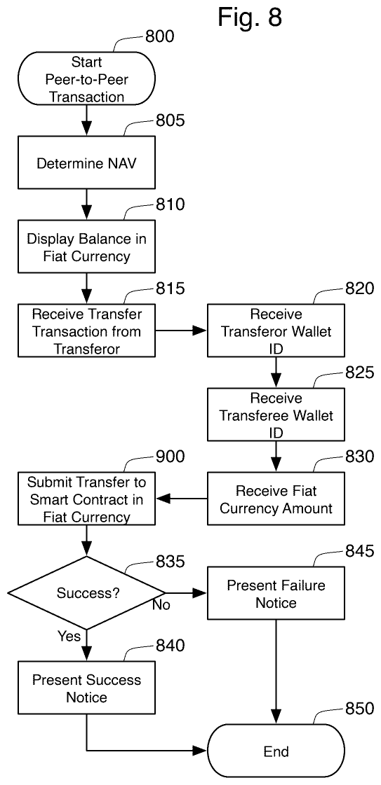

The next step shown in the overall method 300 is the merchant transaction method 700, shown and described in connection with FIG. 7. The merchant transaction method 700 allows the use of the coins to be used as part of a commercial transaction with a merchant. Such a transaction results in the transfer of coins to the merchant wallet 134. These types of transactions specify the amount of the transfer in a fiat currency, and the method 700 utilizes the NAV 160 to determine the number of coins to transfer without requiring the redemption of coins into fiat currencies. Similarly, the peer-to-peer transaction method 800, which is shown as the next step in overall method 300 and in detail at FIG. 8, allows the exchange of coins between individuals, such as the transfer of coins from first wallet 124 to second wallet 128.

Although the initiation method 400 is the first step of the overall method 300, the remaining sub-methods 500, 600, 700, 800 do not need to occur in any order. Rather, these sub-methods merely define the various processes that can be implemented using the system 100. Each of these methods relies upon the operation of smart contracts 112, in that each involve the transfer of coins on the blockchain 110. Each transfer requires the use of a smart contract 112, and as explained below, each transfer will involve utilizing the oracle interface 114 to determine the NAV for the transaction.

Periodically, the operational server 140 will need to pay various expenses, which occur at the expenses and liabilities step 310. These expenses comprise the costs associated with operating the system 100. When expenses are paid, this will directly reduce the value of the assets 152 tracked in the operations database 150. Liabilities that have been accrued will also be tracked at step 310, which will alter the value of the outstanding liabilities 154 tracked by the operations database 150.

In addition to other expenses and liabilities, step 310 is responsible for paying taxes based on the income earned by the assets in the operations account 192. As explained above, such income can include interest income, dividends, and capital gains. Such income is not passed through to customers, clients, or owners, but is retained by the entity that operates the operational server 140. As such, under US tax law, the operator of the system 100 will likely not qualify for treatment as a “regulated investment company” under Subchapter M of the US Internal Revenue Code of 1986 as amended. Instead, the entity will itself pay tax on net income generated by the assets in the operations account 192. Tax liabilities accrued or paid will be reflected in the outstanding liabilities 154 and assets 152 values maintained by the operations database 150, and therefore will impact the value of the NAV. Other than the income used for taxes and other liabilities and expenses, all net income earned by the operations account 192 will be retained and reinvested, and thereby generate increased value in the NAV 160.

In some embodiments, the owners of the coins minted and maintained by the smart contracts 112 on the blockchain 110 will be considered owners of the equity maintained in the operations account 192. It is likely that coin owners would be subject to governmental tax only when their coins are sold or transferred, and that such tax would be based on the owner's change in basis of the coins sold or transferred. Depending on ownership tenor, any such income may be classified as ordinary income or capital gains (under US tax rules). Tax would not, however, need to be paid on the interest or other income earned by the assets in the operations account 192 as it is earned, as such taxes are paid at the level of the overall system 100 in step 310. Thus, the value of individual coins will increase over time based on the income earned on the assets (minus taxes and expenses). Such a result is not possible with any of the technological approaches to stablecoin and interest-bearing coins known in the prior art.

Step 310 is therefore responsible for maintaining the value of the outstanding liabilities 154 and for keeping this value current. Step 320 is responsible for periodically determining the overall value of the assets maintained in the operations account 192 and keeping the assets 152 value current. Step 330 is then responsible for calculating the NAV 160 using the formula described above.

In one embodiment, the calculating of the NAV 160 occurs once daily after the closing of local markets. As explained below in connection with FIGS. 5 and 6, the acquisition and redemption of coins using the coin acquisition method 500 and the redemption method 600 may include a transaction wait period. In embodiments where the NAV 160 is updated daily, these transaction wait periods allow transactions to be requested throughout a day, but to be filled only after the closing of local markets, or more particularly, at the time of the daily recalculation of the NAV 160. As is also explained below, the preemptive minting of additional coins and the preemptive selling of assets may also take place at this time (as part of step 330). After the NAV 160 is re-determined, it is shared with the oracle interface 114 in one of the manners described above. In FIG. 3, the overall method 300 will then end at step 340. In actuality, however, the steps shown in FIG. 3 are not sequential, and the method can continue performing all of the steps (other than, perhaps, the initiation method 400) throughout the operational life of the system 100. Although it is not shown in FIG. 3, the periodic determination of the NAV at step 330 can also occur at the same time that the assets held by the system 100 in the operations account 192 can be evaluated for performance and liquidity and then reinvested as appropriate.

### Initiation Method 400

FIG. 4 shows the initiation method 400, which starts at step 410 with receiving the initial assets needed to capitalize the system 100. These assets will generally be relatively liquid financial assets, and these will then be invested in the operations account 192 (which, as explained above, would likely be implemented as multiple accounts in multiple locations). This investment occurs at step 420.

At step 430, coins are minted using one of the smart contracts 112 found on the blockchain 110. The number of coins to be minted in this step 430 depends on the total value of the assets received and invested at step 410 as well as the selection of an initial NAV. The initial NAV can be arbitrary, but it is generally preferred that the initial NAV be a one-to-one valuation with a selected fiat currency. In the United States, the most likely fiat currency is the US dollar. Thus, the initial NAV could set the value of one minted coin to be equal to one US dollar. The number of coins to be minted at step 430 would be equal to the dollar value of the initial assets received at step 410.

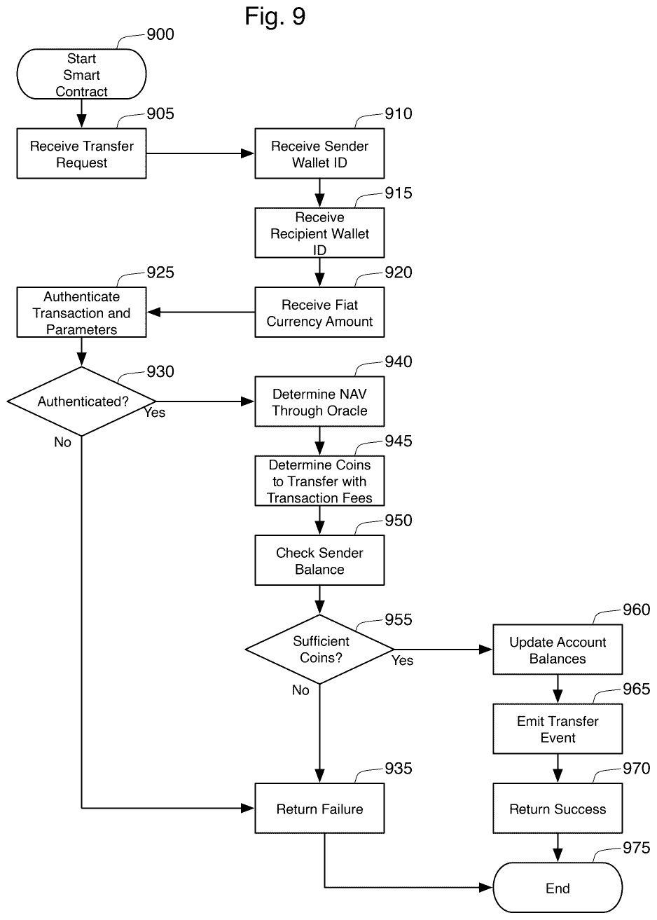

Coins are minted at step 430 using a minting smart contract 112 written for this purpose. In one embodiment, the request sent to the minting smart contract 112 will be specified not in a numerical number of coins to be minted, but through a fiat amount. As is the case for the transfer smart contract described below in connection with FIG. 9, this smart contract can accept a fiat amount as an input parameter, read the current NAV value from the oracle interface 114, and then convert the fiat amount received in the request to a particular number of coins to be minted by dividing the fiat amount by the current NAV value.

At step 440, the initial NAV is calculated and shared with the blockchain 110 through the oracle interface 114. Obviously, if the total number of coins minted at step 430 was selected to create a one-to-one NAV with the fiat currency, the initial NAV value 160 would be exactly one. Next, the minted coins need to be assigned to the operations wallet 144 on the blockchain 110. This is also accomplished using a smart contract 112. The method performed by the coin transfer smart contract 112 is shown as method 900 in FIG. 9 and is described in more detail below. Alternatively, the assignment of coins to the operations wallet 144 could have been performed as part of method step 430. The initiation method 400 then ends at step 460.

### Acquisition Method 500

FIG. 5 shows the coin acquisition method 500. This method allows a client using the first computing device 120 to purchase coins using the system 100. The first step is to provide a client login portal at step 505. This portal is provided through network 170 by the operational server 140 to the wallet app 122 over the network connections 172. In one embodiment, the operational server 140 provides a web interface that includes a web wallet application 122 that can be viewed by the first user over a standard browser. In other embodiments, the wallet app 122 is a separate application operating on the first computing device 120, such as a computer application operating on a personal computer 120 or a mobile device app operating on a smartphone or tablet that is operating as the first computing device 120. The login portal provided by step 505 includes the ability for a user to authenticate themselves, such as a username and password. Other authentication techniques can be utilized, and, where appropriate, two-factor authentication will be required.

Step 510 determines whether the individual logging in is an existing and valid customer using, in part, the client data 158 stored in operations database 150. If not, step 515 will treat the user as a new customer. New customers will be subject to Know Your Customer (KYC), Anti-Money Laundering (AML), and Counter Financing of Terrorism (CFT) evaluation processes. These processes are also consistent with those required for the initial sale of non-security stablecoins regulated by the New York State Department of Financial Services (“NYSDFS”). In effect, step 515 will acquire sufficient information and proof of identity from the clients in order to satisfy these various requirements. This information will then be stored as client data 158. Once the new customer is established, then the customer can then log in again via step 505.

When a customer logs in, information about the coins in their wallet will be presented. For the first user, information about the first wallet 124 will be disclosed. This information will utilize the current NAV 160 in order to present the value of the coins held in the first wallet 124 in terms of the underlying fiat currency. If for instance, a customer held 1,000 coins, and the current NAV was 1.1 (and the underlying fiat currency was US dollars), the displayed value for the coins held in the first wallet 124 would be $1,100. This of course would be true even if the customer had only previously purchased $1,000 worth of coins at a NAV of 1.0. The extra $100 of value in the coins would be based on the increase in the NAV based on value earned by the assets held by the system 100.

The interface that presents this wallet information would also present options for the client to either acquire more coins or redeem coins. Assuming that a selection of one of these options was made, step 520 determines whether the selected option was redemption or acquisition. If the selection was to redeem currently owned coins, then redemption method 600 is performed, as described below.

If the client chooses to acquire additional coins, step 525 will receive an indication of the amount of coins that the client wishes to purchase. In most embodiments, this amount will be provided in fiat currency. Once selected, the coin acquisition method 500 will receive this amount of funds from the client at step 530. Step 530 may result in the transfer of fiat currency out of, for example, the first account 182 and into an account held by the operator of the system 100, such as the operations account 192.

At step 535, the coin acquisition method 500 waits for a transaction period to arrive. In the preferred embodiment, the purchase of coins through the coin acquisition method 500 and the sale of coins through the redemption method 600 both ensure that all transactions submitted during the day occur at approximately the same time. As explained above, this transaction period is also the time that the NAV is established at step 330. The fact that the NAV can change between the time that the client submits the purchase amount at step 525 and the time the coins are actually minted and transferred to the client is the reason that the purchase amount received from the client is specified in fiat currency amounts and not in number of coins.

Once the transaction period has arrived, and the new value for the NAV has been calculated, additional coins are preemptively minted at step 540. As was the case with the initial minting of coins in method 400, the newly minted coins in step 540 will also be assigned to the operations wallet 144. The number of coins minted at this step 540 will be based on the amount of funds received at step 530 and the newly create NAV value 160. The process for minting these coins can be the same as the process described above for the initial minting of coins at step 430. This means that a separate smart contract 112 might be used for the minting of these coins. As was the case with step 430, the request to mint coins may be submitted to this minting smart contract 112 not by using a number of coins, but by specifying a fiat currency value.

In one embodiment, the newly minted coins are assigned to the operations wallet 144. In these embodiments, the next step is to submit a transfer request denominated in fiat currency numbers to a transfer smart contract through method 900. In particular, the coin acquisition method 500 will submit the transaction details to method 900, including the operations wallet 144 as the transferor, the client wallet 124 as the transferee, and the fiat amount for the transfer. In other embodiments, the same smart contract that mints the coins in step 540 is responsible for transferring the coins using the method described below in connection with FIG. 9. In this case, the smart contract needs to receive as parameters the fiat amount to determine the number of coins to mint, and the client wallet 124 as the recipient of the newly minted coins. Note that the very coins that are newly minted coins which end up being assigned to the client wallet 124 in this case. This need not be the case using the previously described embodiment, where the minted coins are associated with the operations wallet 144, and the transfer method 900 is only responsible for ensuring that some coins (not necessarily the newly minted coins) are transferred from the operations wallet 144 to the client wallet 124.

Note that the method in FIG. 5 can handle multiple acquisition requests throughout a day. If multiple clients have requested an acquisition of coins during the day, a single minting of coins for the total required amount can be performed at step 540 for all of the transactions that need to be completed. A separate transfer request would need to be submitted for each of the accumulated acquisition requests received since the last transaction period to ensure that the proper client wallet 124 receives the appropriate number of coins.

If this method 900 completes successfully (as determined by step 550), the appropriate number of coins will have been transferred to the first wallet 124. At step 555, the successful acquisition will be reported to the client. In addition, step 555 is responsible for ensuring that the funds received at step 530 are appropriately transferred to the operations account 192 (if they have not already been so transferred) and invested. If method 900 does not complete successfully, then step 560 indicates to the client that the purchases did not complete successfully. The funds received at step 530 will be returned to the client at step 560. Step 565 will then burn any preemptively minted coins that were minted at step 540 but are no longer required (as the transfer to the client wallet 124 was not completed). After either step 555 or step 565, the method ends at step 570.

Note that method 500 can be utilized at any time during the operation of the system 100. Thus, the receipt of the acquisition request 520 may occur after an existing NAV 160 has been calculated and stored through the oracle interface 114. This means that the existing NAV 160 is calculated and stored at a first time, the acquisition request is received at a second time, and a new NAV value is determined and stored through the oracle interface 114 at a third time. It is this new NAV value (based on values 152, 154, and 156 that have been updated between the first and third times) that is then used to determine the number of coins transferred through the smart contract method 900.

### Redemption Method 600

In FIG. 6, the redemption method 600 is shown. Note that this method 600 is triggered from the coin acquisition method 500 after step 520. In this situation, steps 505, 510, 515, 520 will have ensured that the client has logged in, that all KYC, AML, and CFT processes have been completed, and that the client has indicated that they wish to redeem some or all of their coins. These steps are therefore not repeated or shown in FIG. 6 even though they are as important a part of the redemption method 600 as they are to the coin acquisition method 500. Thus, method 600 starts with the client having already initiated the redemption process. The first step 605 receives an indication of the amount of coins that they wish to redeem. Like step 525, step 605 receives this indication in the fiat currency. For example, step 605 may receive an indication that $1,000 worth of coins should be redeemed. Alternatively, step 605 may receive an indication that all of the client's coins should be redeemed.

At step 610, the operational server 140 will determine whether sufficient cash exists in its accounts to handle this transaction. If not, step 615 is responsible for preemptively selling assets in order to acquire sufficient cash for the transaction. Step 620 then waits for the next transaction period. As already explained, one embodiment of the present invention allows acquisition or redemption only once per day. Thus, step 620 simply waits for this period to occur (and for the NAV to be updated).

Once the transaction period has arrived, the redemption method 600 will submit the transaction details to method 900 for handling by the smart contract 112. These transaction details will identify the client wallet 124 as the transferor, the operations wallet 144 as the transferee, and the fiat amount for the transfer. If the smart contract completes method 900 successfully (as determined by step 625), step 630 will provide an indication of success to the client. In addition, funds held by the entity operating the operational server 140 will be transferred to a fiat currency account of the client, such as the first account 182 associated with the first user.

Furthermore, also at step 630, the coins received by the transfer method 900 will be burned. In this way, the value of the system's assets 152 will be reduced at the same time that the number of outstanding coins 156 is reduced, so as to not alter the calculated NAV 160. The burning of coins is also performed by a smart contract 112. In one embodiment, a single redemption smart contract 112 is responsible for transferring coins at step 625 and burning coins at step 630. In other embodiments, a first smart contract 112 transfers the coins from the client wallet to the operations wallet, and a second smart contract 112 is responsible for burning the appropriate number of coins of those currently held by the operations wallet.

If the smart contract 112 is not successful, step 635 indicates the failure of the redemption to the client. Step 640 will then, optionally, transfer any cash assets acquired at step 615 back into investment assets. After either step 630 or 640, the redemption method 600 ends at step 645.

Note that one reason the smart contract 112 would not be successful is that the first wallet 124 associated with the user of the blockchain 110 does not have sufficient coins for the requested redemption amount. Although it is not shown in FIG. 6, it is contemplated that step 605 will verify that the first wallet 124 has sufficient coins for the requested redemption amount at the then current NAV 160. As the NAV 160 will be reset during step 620, it is possible that this check will not be sufficient, thus the redemption may still fail at step 635 even if it were preliminarily approved at step 605.

### Merchant Transaction Method 700

FIG. 7 shows the merchant transaction method 700, in which a transaction is executed at a merchant location (physical or virtual) where which goods or services are sold in exchange for coins on the blockchain 110. This method 700 utilizes the POS system 136 introduced above which communicates with the wallet app 132 for the merchant. While the implementation details are not determinative as to how the overall system 100 will function, in one embodiment the POS system 136 itself includes all of the necessary components to communicate with the operational server 140 over network connections 172 and to communicate with blockchain 110 over blockchain communication paths 102. In other embodiments, the wallet app 132 will provide these capabilities, and the wallet app 132 will effectively act as a plug-in to an otherwise standard POS system 136.

The merchant transaction method 700 begins with step 705, where the system 100 receives purchase transaction details from the POS system 136. The receipt of this information by the system 100 can take place when the POS system 136 communicates with either a wallet app 132 or directly with the operational server 140. These transaction details must include at least three essential elements of data, which are shown as separate steps in FIG. 7. First, the identifier for the customer wallet must be received (such as the first wallet 124 if the first user is engaging in this transaction). This is shown as step 710. Second, the identifier for the merchant wallet 134 is received at step 715. Third, the transaction amount specified in the fiat currency (not in the number of coins) is received at step 720.

At step 725, the merchant transaction method 700 determines the current NAV. This is determined utilizing the oracle interface 114 described above. Next, at step 730, the current NAV and the fiat currency amount from step 720 are utilized to determine the number of coins that must be transferred for this transaction. At step 735, the balance in the customer wallet 124 is consulted, and step 740 determines whether sufficient coins for the transaction are currently owned by the customer. If not, step 745 indicates that this transaction has failed, and a failure notice is reported back to the POS system 136.

If step 740 indicates that sufficient coins are currently owned by the first wallet 124, then step 750 presents the transaction details back to the POS system 136 for final confirmation by the merchant and/or the customer. The POS system 136 can then report back whether the transaction details have been confirmed by one or both parties. If not, then step 755 will detect this and the method will proceed to step 745 with a notice of failure.

If the transaction was confirmed, then the merchant transaction method 700 will submit the transaction details to the smart contract method 900. This method 900 will report back its success or failure. If the smart contract 112 executed successfully (as determined by step 760), then a success notice is reported back to the POS system 136 at step 765. If not, then the failure notice is provided at step 745. Either way, the method 700 ends at step 770.

Note that steps 725, 730, 735, 740, 750, and 755 are optional steps, but the inclusion of these steps may ease concerns from customers during the initial implementation of the system 100 that the correct number of coins will be used to pay for the current transaction. If these steps were omitted, the method would move from step 725 to the submission of the transaction details to the smart contract method 900. It will be noted that these optional steps determine the NAV 160 before submission of the transaction details to the smart contract method 900. These optional steps also determine if the customer has a sufficient balance of coins in their wallet for the transactions. These steps will be performed by the smart contract method 900, so they do not have to be performed before submission to the smart contract 112. These optional, additional steps are only shown so that a confirmation request can be sent back to the customer and the merchant in step 750, and so that this confirmation request can show the actual number of coins being transmitted. Since the confirmation steps 750, 755 are themselves optional, then other steps 725, 730, 735, and 740 can be omitted if confirmation is not required.

### Peer-to-Peer Transaction Method 800

FIG. 8 shows the peer-to-peer transaction method 800. This method 800 is used when two, non-merchant users wish to transfer coins on the blockchain 110 to one another. In this example, the first user wishes to transfer coins from their first wallet 124 to the second wallet 128 owned by the user of the second computing device 126 (the “second user”). In this case, the wallet app 122 will present a user interface to the first user displaying the value of coins currently held in the first wallet 124. To be able to accomplish this, the peer-to-peer transaction method 800 first, at step 805, determines the current NAV. This can be determined by the wallet app 122 either by directly reading the NAV through the oracle interface 114, or by requesting this information directly from the operational server 140 over the network 170. After the NAV is determined, wallet app 122 determines the number of coins in the first wallet 124 and converts this to a fiat currency value for those coins. This is then displayed to the first user at step 810.

At step 815, the wallet app 122 receives a request for a transfer transaction. As was the case with the merchant transaction method 700, three elements of data are essential to be included in this request, namely the transferor's wallet ID (shown as step 820 in FIG. 8), the transferee's wallet ID (step 825), and the fiat currency amount of the transfer request (step 830). In the current example, the transferor's wallet ID is the identifier for the first wallet 124 and the transferee's wallet ID is the identifier for the second wallet 128.

Next, the wallet app 122 submits the transfer request with this data to the smart contract method 900 for the transfer of these coins. At step 835, the method determines whether the transfer was successful based on the status information returned by the smart contract 112. If so, step 840 returns a success notification to the first user. If not, step 845 returns a failure notification. Either way, the method 800 then ends at step 850.

Note that while this peer-to-peer transaction method 800 was described as being performed using a wallet app 122 operating on the first computing device 120, as explained above it is equally possible that the wallet app 122 takes the form of a web interface provided directly by the operational server 140.

Furthermore, note that neither the merchant transaction method 700 nor the peer-to-peer transaction method 800 include a step corresponding to a user login into the operational server 140 or a KYC/AML check that was shown in connection with the coin acquisition method 500 and the redemption method 600. This means that while customers involved in coin acquisition and redemption are known to the system 100 through client data 158, the coin holders involved in the merchant or peer-to-peer transactions remain pseudonymous to the system 100 (with only the participant's digital currency wallet addresses being known). This is because only customers involved in acquisition and redemption need to be considered customers for current KYC/AML regulations in the United States. Secondary transfers can take advantage of the public, decentralized blockchain 110 to maintain a complete and immutable ledger of coin ownership, which securely records ownership transfers while remaining pseudonymous. Nonetheless, the recipients of these secondary transfers fully participate in the change in value of the coins that they own through the changing NAV value 160.

### Smart Contract Method 900

FIG. 9 shows a flow chart explaining the operation of a transfer smart contract 112. This method 900 is shown as part of numerous methods described above, such as initiation method 400, coin acquisition method 500, redemption method 600, merchant transaction method 700, and peer-to-peer transaction method 800. While it is possible to actually implement each of these methods by calling a single, smart contract that operates according to method 900, it is not necessary that the above methods be implemented in exactly this manner. For example, a smart contract 112 could be created for the initiation method that directly handles the transfer of coins during initiation. This smart contract 112 could perform additional steps shown in FIG. 4 beyond that identified as being performed by smart contract method 900. It is generally expected, however, that the basic method for transferring coins on the blockchain 110 will utilize a smart contract process similar to that shown in FIG. 9.

Method 900 begins with receiving the transfer request 905. The transfer request is a request to transfer coins from a sender to a recipient. Therefore, the request received at step 905 must have a sender wallet identifier (which is shown as being received in separate step 910) and a recipient wallet identifier (step 915). In addition, the transfer request must identify how much is to be transferred. In method 900, this is indicated using the fiat currency amount, as shown in step 920. The specification of the amount to transfer to the smart contract 112 in fiat currency can form an important part of the disclosed embodiments. This means that each interface that interacts with the smart contract 112 need only specify fiat currency amounts, and a smart contract 112 is the one and only mechanism for converting between the specified fiat currency and the exact number of coins (and fractional coins) that are to be transferred. This prevents fraudulent interfaces from convincing users to transfer an inappropriate number of coins for a particular transaction. Note that other stablecoin cryptocurrencies need not address any conversion between fiat amounts and number of coins, since the PEG is traditionally maintained at a one-to-one ratio in these cryptocurrencies. The present invention achieves a technically non-fixed peg while maintaining a stable, appreciating currency, in large part by relying on the smart contract 112 and oracle interface 114 to handle all conversion calculations.

At step 925, the smart contract 112 authenticates the transaction and its parameters. This authentication step 925 ensures that the request to perform the token transfer is both legitimate and authorized. In one embodiment, the authentication includes verifying that the entity initiating the transaction has the requisite authority to affect the transfer of tokens from the specified sender wallet ID. For example, the smart contract can compare the address of the transaction sender to the source address specified in the transaction parameters. If the sender is not the source address, the smart contract further verifies that the sender has been previously granted an allowance or delegation to transfer tokens on behalf of the source address, such as by consulting an internal data structure (e.g., an approval mapping). Authentication may also include validation of the transaction parameters themselves. This can involve confirming that the destination address is not null or invalid, that the specified transfer amount is greater than zero, and that the source and destination addresses are not identical.

In some embodiments, the authentication logic may also consult a list of restricted addresses (e.g., blacklists or sanctioned entities), enforce compliance rules, or perform additional pre-transfer validations as dictated by the smart contract's business logic. For example, the smart contract may reference one or more lists of prohibited wallet addresses, including addresses identified by governmental or regulatory bodies such as the U.S. Department of the Treasury's Office of Foreign Assets Control (OFAC) Specially Designated Nationals and Blocked Persons (SDN) List. The smart contract may be configured to prevent transactions involving any wallet address that appears on such a list, thereby ensuring adherence to applicable sanctions regimes. Additionally, the smart contract may integrate with third-party compliance data providers or oracles to obtain up-to-date information regarding restricted addresses or entities associated with illicit activity, money laundering, terrorism financing, or other regulatory concerns. These compliance rules may be enforced automatically and programmatically within the smart contract logic, thereby reducing the risk of human error and enabling decentralized enforcement of legal or policy constraints. This authentication step 925 helps ensure the integrity of the smart contract's state and assists in complying with governmental regulations and sanctions policies.

If step 930 indicates that the transaction was not authenticated, then a failure is returned at step 935, and the method ends at step 975. If the transaction was authenticated, then step 940 utilizes the oracle interface 114 to determine the NAV. The mechanism by which the NAV is accessed depends on the implementation of the oracle interface 114. In embodiments employing a centralized oracle, the NAV is typically retrieved from a data payload previously submitted by the operational server 140 as a signed, timestamped transaction to the blockchain. The smart contract reads this value from the most recently published NAV entry and uses it in subsequent calculations. In decentralized oracle implementations, the NAV is accessed from an aggregate value posted by multiple independent oracle nodes after achieving consensus on data authenticity and accuracy. In a time-locked or commit-reveal configuration, step 940 would require reading a previously committed hash and waiting for the corresponding NAV data to be revealed and verified against that commitment before proceeding. Each of these approaches allows the smart contract to obtain a verifiable NAV value 160.

The NAV 160 from step 940 and the received fiat currency amount received at step 920 are then used to calculate the number of coins (including fractional coins) to include in this transaction at step 945. This involves dividing the fiat-denominated transaction value by the NAV 160 to determine the corresponding quantity of digital coins. At step 950, the sender wallet is checked to determine that the wallet is associated with a sufficient number of coins to complete the transaction. This verification is conducted against the internal ledger maintained by the smart contract. If the sender does not hold a sufficient number of coins, this is detected at step 955 and a failure is returned at step 935, terminating the transaction.

If the sender wallet owns sufficient coins, then the account balances are updated at step 960. This involves decrementing the sender's balance and incrementing the recipient's balance within the smart contract's internal ledger. These balance updates are necessary to reflect the actual transfer of ownership of the cryptocurrency coins and ensure that future queries to the smart contract accurately reflect token holdings.

Step 965 then emits a transfer event to the blockchain 110. Emitting the transfer event does not itself affect balances, but instead serves as a formal, on-chain record of the transaction. Blockchain events are logged as part of the transaction receipt and can be monitored by external systems or wallet applications to confirm that a transfer occurred. This event includes data such as the sender address, recipient address, number of tokens transferred, and timestamp. In some embodiments, the event includes data identifying the fiat-denominated transaction value, the NAV used to calculate the number of coins, or both. Events provide transparency and allow decentralized applications to respond in real-time to blockchain activity.

Finally, a successful result status is returned at step 970. The method 900 ends at step 975, which may be reached either after this successful result or after a failure is returned at step 935.

The many features and advantages of the invention are apparent from the above description. Numerous modifications and variations will readily occur to those skilled in the art. Since such modifications are possible, the invention is not to be limited to the exact construction and operation illustrated and described. Rather, the present invention should be limited only by the following claims.

What is claimed is:

1. A method for acquiring cryptocurrency coins, the method comprising:
a) calculating a first Net Asset Value (NAV) at a first time based on an asset value divided by a number of outstanding coins;
b) providing the first NAV to a decentralized blockchain via an oracle interface, wherein the oracle interface is configured to make the first NAV accessible to smart contracts on the decentralized blockchain;
c) receiving at a second time after the first time, from a purchaser, a request to acquire the cryptocurrency coins, the request specifying a fiat-denominated purchase amount and a purchaser wallet address;
d) receiving funds from a purchaser of an amount equal to the fiat-denominated purchase amount;
e) waiting until a transaction period that is after the second time to calculate a second NAV based on an updated asset value divided by an updated number of outstanding coins;
f) providing the second NAV to the decentralized blockchain via the oracle interface; and
g) at a smart contract,
i) receiving the fiat-denominated purchase amount and the purchaser wallet address,
ii) receiving the second NAV from the oracle interface on the decentralized blockchain,
iii) calculating a number of coins by dividing the fiat-denominated purchase amount by the second NAV,
iv) minting the number of coins, and
v) transferring the number of coins to the purchaser wallet address
by updating a coin balance associated with the purchaser wallet address and emitting a transfer event on the decentralized blockchain.

2. The method of claim 1, wherein minting and transferring of the coins are performed by a single smart contract.

3. The method of claim 1, wherein a first smart contract mints the number of coins as minted coins and assigns ownership of the minted coins to an operations wallet, and a second smart contract transfers the number of coins from the operations wallet to the purchaser wallet address.

4. The method of claim 3, further comprising submitting a transaction request to the second smart contract to request a transfer of the number of coins to the purchaser wallet address, the transaction request identifying these transaction parameters:
i) an operations wallet address,
ii) the purchaser wallet address, and
iii) the fiat-denominated purchase amount;
wherein the first smart contract and the second smart contract each access the second NAV from the oracle interface to determine the number of coins.

5. The method of claim 4, further comprising authenticating, by the second smart contract, the transaction request.

6. A method for redeeming cryptocurrency coins, the method comprising:
a) calculating a first Net Asset Value (NAV) at a first time based on an asset value divided by a number of outstanding coins;
b) providing the first NAV to a decentralized blockchain via an oracle interface, wherein the oracle interface is configured to make the first NAV accessible to smart contracts on the decentralized blockchain;
c) receiving at a second time after the first time, from a holder, a request to redeem the cryptocurrency coins, the request specifying a fiat-denominated redemption amount and a holder wallet address;
d) waiting until a third time that is after the second time to calculate a second NAV based on an updated asset value divided by an updated number of outstanding coins;
e) providing the second NAV to the decentralized blockchain via the oracle interface;
f) waiting until after the third time to submit a transaction request to a smart contract operating on the decentralized blockchain, the request identifying the holder wallet address and a fiat-denominated transaction amount;
g) receiving, by the smart contract, the second NAV from the oracle interface on the decentralized blockchain;
h) calculating, by the smart contract, a number of coins by dividing the fiat-denominated transaction amount by the second NAV;
i) transferring, by the smart contract, the number of coins from the holder wallet address by updating coin balance associated with the holder wallet address and emitting a transfer event on the decentralized blockchain;
j) transferring the fiat-denominated redemption amount to the holder; and
k) burning the number of coins.

7. The method of claim 6, wherein the number of coins transferred from the holder wallet address are transferred by the smart contract to an operations wallet address; and further wherein the number of coins that are burned are held by the operations wallet address before being burned.

8. The method of claim 6, wherein a single smart contract is responsible for transferring of the number of coins from the holder wallet address and for burning the number of coins.

9. A method for transferring cryptocurrency coins in a transaction between a sender and a recipient, the method comprising:
a) calculating a Net Asset Value (NAV) based on an asset value for financial assets minus liabilities, divided by a number of outstanding coins;
b) providing the NAV to a decentralized blockchain via an oracle interface, wherein the oracle interface is configured to make the NAV accessible to smart contracts on the decentralized blockchain;
c) receiving a transaction request at a smart contract operating on the decentralized blockchain, the transaction request identifying these transaction parameters:
i) a sender wallet address,
ii) a recipient wallet address, and
iii) a fiat-denominated transaction amount;
d) receiving, by the smart contract, the NAV from the oracle interface;
e) calculating, by the smart contract, a number of coins by dividing the fiat-denominated transaction amount by the NAV; and
f) transferring, by the smart contract, the number of coins by updating a coin balance at the sender wallet address and the recipient wallet address and emitting a transfer event on the decentralized blockchain.

10. The method of claim 9, further comprising authenticating, by the smart contract, the transaction request including verifying that the sender wallet address is authorized to initiate the transaction and that the fiat-denominated amount and recipient wallet address are valid.

11. The method of claim 9, further comprising, authenticating, by the smart contract, that the sender wallet address is not included in a restricted address list and that the recipient wallet address is not included in the restricted address list.

12. The method of claim 9, wherein calculating the number of coins comprises performing a division of the fiat-denominated transaction amount by the NAV to a precision sufficient to support fractional coins.

13. The method of claim 9, wherein the transfer event emitted by the smart contract includes the fiat-denominated transaction amount and the NAV used to calculate the number of coins.

14. The method of claim 9, wherein the oracle interface is implemented as a centralized oracle, wherein the centralized oracle posts a signed and timestamped NAV data to the decentralized blockchain prior, and wherein the smart contract receives the NAV from the oracle interface by accessing the signed and timestamped NAV data.

15. The method of claim 9, wherein the transaction request is initiated as part of a merchant transaction at a point-of-sale (POS) system between a merchant and a customer, and the fiat-denominated transaction amount is received from the POS system.

16. The method of claim 15, further comprising presenting a calculated number of coins to be transferred, based on the fiat-denominated transaction amount and the NAV, to at least one of the merchant and the customer for a confirmation prior to execution; receiving the confirmation of the transaction; and then proceeding with the transferring of the number of coins only after receiving the confirmation.

17. The method of claim 9, wherein the NAV is calculated by an operations server, wherein the operations server maintains operations data that tracks values for financial assets, liabilities, and the number of outstanding coins.

18. The method of claim 17, wherein the financial assets are held in one or more operations accounts, wherein the financial assets earn a return that changes the value of the financial assets over time, and wherein changes in the value of the financial assets alter the NAV.

19. The method of claim 18, wherein governmental taxes owed on the return earned by the financial assets are paid by an operator of the operations server, and wherein a payment or an accrual of such taxes alters the value of the financial assets or liabilities, such that the NAV reflects the return earned by the financial assets net of taxes.

20. The method of claim 19, wherein no portion of the return earned by the financial assets is directly distributed to holders of the cryptocurrency coins, and wherein the return is instead reflected solely through increases in the NAV.
